(19) United States
(12) Patent Application Publication
(10) Pub. No.: US 2007/0299719 A1
(43) Pub. Date: Dec. 27, 2007

(54) Professional rating system and method

(76) Inventor: Lucas Stolba, Vancouver (CA)

Correspondence Address: Fasken Martineau DuMoulin LLP, 2100 - 1075 West Georgia Street, Vancouver, BC, V6B 3G2, US

(21) Appl. No.: 11/540,570

(22) Filed: Oct. 2, 2006

Related U.S. Application Data
(63) Continuation of application No. PCT/CA06/01050, filed on Jun. 27, 2006.

(51) Int. Cl. G06F 11/34

(52) U.S. Cl. 705/11

(57) ABSTRACT

A system for rating professionals is provided, comprising: (a) means for storing information about a plurality of professionals in a database, including a name and contact information of each of said professionals; (b) means for a user to search said database via a web site; (c) means for said user provide the name and contact information of a professional to said database; and (d) means for said user to provide a rating of said professional. The rating may be based on the expertise of said professional, the cost of said professional or the ethics of said professional, and may include a comment about the professional. The web site preferably has means for said user to search said database by selecting a category of professionals, a subcategory of professionals and a geographic area for said professional.

This application is a continuation-in-part of PCT Application No. PCT/CA2006/001050 filed Jun. 27, 2006.

### FIELD OF THE INVENTION

The invention relates to Internet based review web sites, and more particularly to such web sites relating to professional criteria.

### BACKGROUND OF THE INVENTION

The Internet and World Wide Web have enabled users to share information widely about products that was previously difficult to accomplish, and was once confined to specific publications, such as Consumer Reports. There are now web sites available to help users learn about various products. Many sites that retail such products include opportunities for purchasers to provide ratings and comments about the products. These sites give new prospective customers an opportunity to compare products before making a purchase.

There are also some web sites on which opinions about different products are collected and posted for the future reference of others. The Internet has made this information accessible worldwide, and these sites provide consumers tools for finding the best products according to their requirements, and avoiding poorly reviewed or rated products.

The collection of comments and remarks for future reference helps generate a healthy competition among the producers of these products. The benefit to consumers includes lower prices, better service, and the ability to avoid poor products.

Computers and web sites may be used to compare predicted results and actual results of professional services, taking the difference and posting a comment for future reference, as described in U.S. Patent Application Publication No. 2003/00416169, entitled “Procurement and Management of Professional Services”, by Fraser et al. U.S. Patent Application Publication No. 2002/0156857 to Brewer at el. describes an on line procedure for acquiring bids from service providers, making a comparison, and making a decision. These solutions deal with very specific professional services in very specific ways.

U.S. Patent Application Publication No. 2002/0038233 to Shubov et al., discloses a system and method for matching professional service providers with consumers; and U.S. Patent Application Publication No. 2003/0163349 discloses a quality rating tool for the healthcare industry. These solutions describe solutions for specifically qualified users.

Other related art includes: U.S. Patent Application Publication No. 2004/0172282 to Benja-Athon; U.S. Patent Application Publication No. 2002/0038233 to Shubov et al.; U.S. Patent Application Publication No. 2003/0163349 to Ho; U.S. Patent Application Publication No. 2004/0220842 to Barney; U.S. Patent Application Publication No. 2004/0133463 to Benderev; U.S. Patent Application Publication No. 2003/0046169 to Fraser et al.; U.S. Patent Application Publication No. 2001/0037219 to Malik; U.S. Patent Application Publication No. 2002/0156857 to Brewer et al.; and U.S. Patent Application Publication No. 2003/0216938 to Shour.

### BRIEF SUMMARY OF THE INVENTION

The system according to the invention provides an Internet web site that allows users to leave comments, ratings and opinions about professionals. The comments are available for future reference, about that particular professional. Users may rate and comment about any sort of professional. A searchable database of professions is available to users, this database not only providing basic information about the professional but also the ratings and comments previously submitted by others. Users will also be able to add their comments through a comment submission procedure.

A method of rating a professional is provided comprising: (a) providing a database, the database containing a plurality of records, each of the records relating to a professional, each of the records storing the name and contact information of the professional; (b) searching through the database for a particular professional using a web site; (c) if the professional is present in a record in the database, providing a rating for the professional; and (d) if the professional is not present in a record in the database, providing the name and contact information of the professional to the database, and providing a rating and/or a comment for the professional. The rating may be based on the expertise of the professional, the cost of the professional or the ethics of the professional. The search may be accomplished by selecting a category of professionals, selecting a subcategory of professionals and selecting a geographic area for the professional.

The web site is preferably accessible to users searching for the rating of the professional and provides an advertisement spot. A second professional may bid on the advertisement spot, and if successful in the bid, may select an advertisement spot for display on the advertisement spot on the web site.

A system for rating professionals is provided, comprising: (a) means for storing information about a plurality of professionals in a database, including a name and contact information of each of the professionals; (b) means for a user to search the database via a web site; (c) means for the user provide the name and contact information of a professional to the database; and (d) means for said user to provide a rating of the professional.

The rating may be based on the expertise of the professional, the cost of the professional or the ethics of the professional, and may include a comment about the professional. The web site preferably has means for said user to search the database by selecting a category of professionals, a subcategory of professionals and a geographic area for the professional.

The web site may also acts as a video directory, including: (a) video presentations (and video advertisements) of businesses, companies or service providers; and (b) video clips supporting any comments submitted about a company, business or service provider.

The web site is preferably accessible to a second user to access the rating of the professional and provides an advertisement spot. A second professional may bid on said advertisement spot, and if successful in the bid, may select an advertisement spot for display on the advertisement spot on the web site.

### BRIEF DESCRIPTION OF THE DRAWINGS

FIG. 1 is flow chart showing the process of accessing the web site and the major modules of a preferred embodiment of a web site according to the invention;

FIG. 2 is a flow chart showing the search process;

FIG. 3 is a flow chart showing the process of adding a professional, and registering with the web site;

FIG. 4 is a flow chart showing the process of adding a comment about a professional;

FIG. 5 is a flow chart showing the components of a member's menu and the use thereof;

FIG. 6 is flow chart showing the process of posting a resume or enhancing the poster's exposure;

FIG. 7 is a flow chart showing the process of selecting priority placement;

FIG. 8 is a flow chart process of selecting and purchasing an advertisement on the web site;

FIG. 9 is a flow chart showing the bidding process;

FIG. 10 is a block diagram showing an implementation of a preferred embodiment of a system according to the invention; and

FIG. 11 is a flow chart showing the process of uploading video files to the web site.

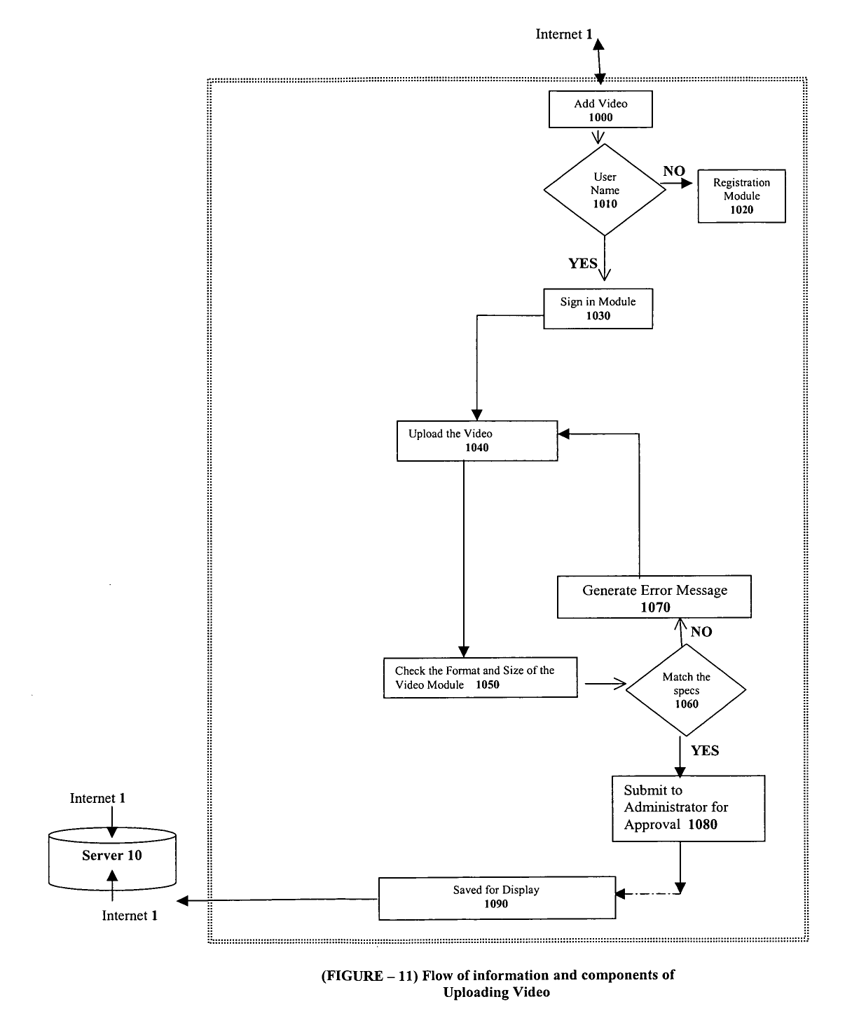

### DETAILED DESCRIPTION OF THE INVENTION

In the present specification and claims, the following terms will have the following meanings:

“advertisement spot” means a location on a web site in which an advertisement can be presented. Such an advertisement may be a banner advertisement, a popup advertisement, video advertisement, or another sort of advertisement found on the Internet;

“home page” means a web page on a web site to which a user typically first hyperlinks to;

“professional” means an individual or organization, such as a company or partnership, that provides professional services to others for a price based on time spent or the services to be provided. Examples of professionals include such traditional professions as doctors, lawyers, accountants, as well as plumbers, electricians, contractors, etc., but excludes teachers, professors, and product retailers;

“subscription user” or “member” means a user having registered with a web site to obtain a user ID and who may provide consideration to access certain modules of the web site;

“user” means an entity capable of using the professional rating system and includes software agents and software robots;

“via” means by means of;

“web page” is a document on the World Wide Web (or Internet). Every web page is identified by a unique Uniform Resource Locator (URL). A web page is a file readable by web browsers and may contain prompts to the user including common user interface controls such as data entry fields, list boxes, drop-down boxes, check boxes, push buttons, radio buttons and the like. In a preferred embodiment, HTML and XML scripts are used to display the pages and accept data from users via the web browser. Using hypertext, a link is a selectable connection from one word, picture, or information object to another. In a multimedia environment such as the World Wide Web, such objects can include sound and motion video sequences. The most common form of link is the highlighted word or picture that can be selected by the user (with a mouse or in some other fashion), resulting in the immediate delivery and view of another file. The highlighted object is the anchor. The anchor reference and the object referred to, constitute a hypertext link; and

“web site” means a unique location on the World Wide Web containing a home page, and also includes non-computer analogues, like URLs printed into the pixels of paper advertisements.

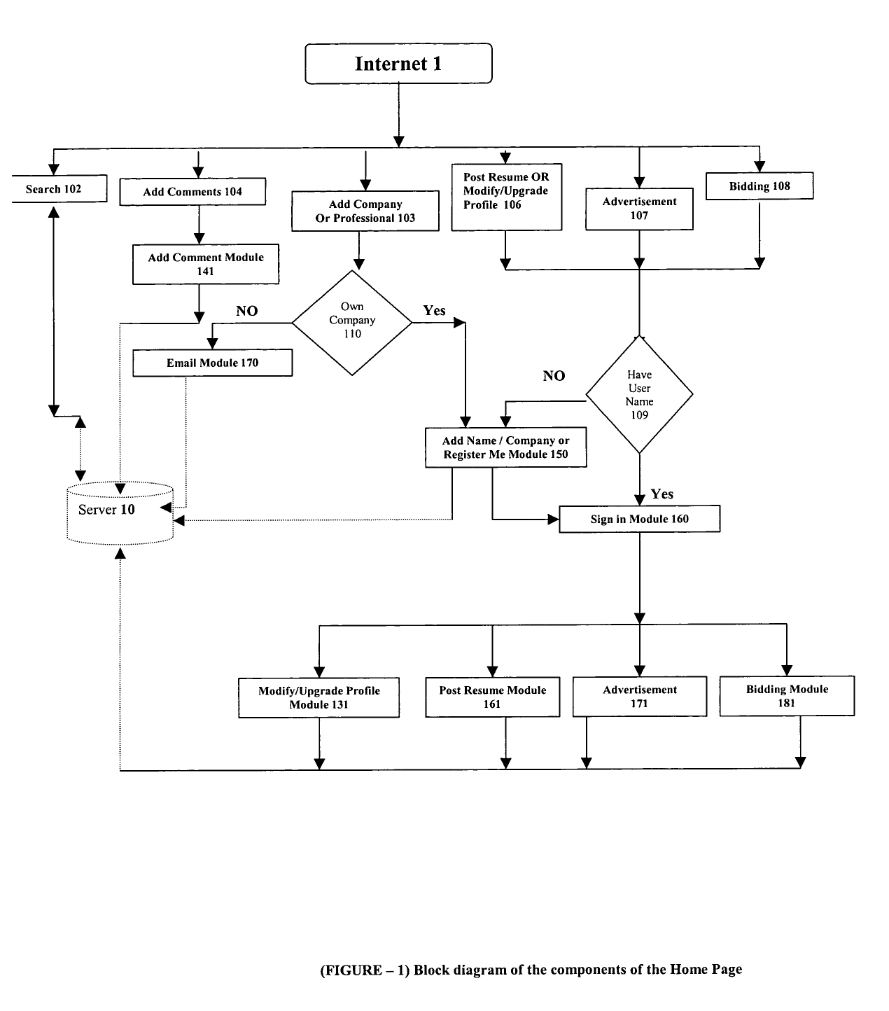

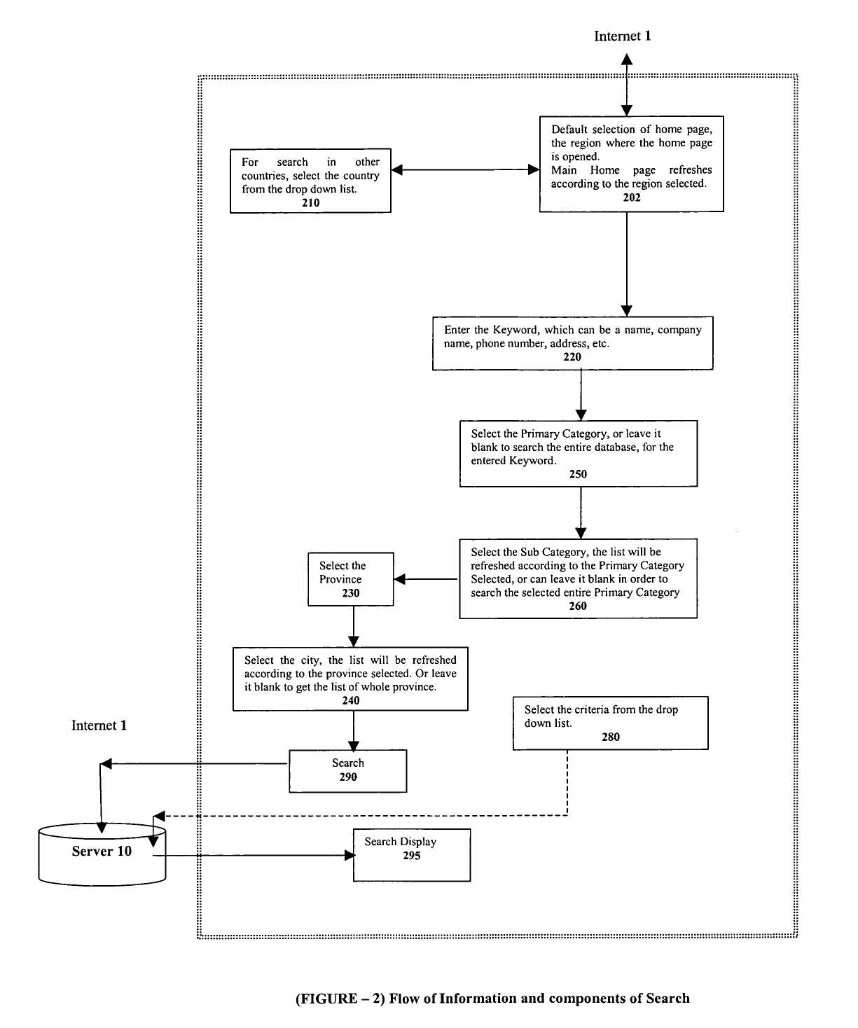

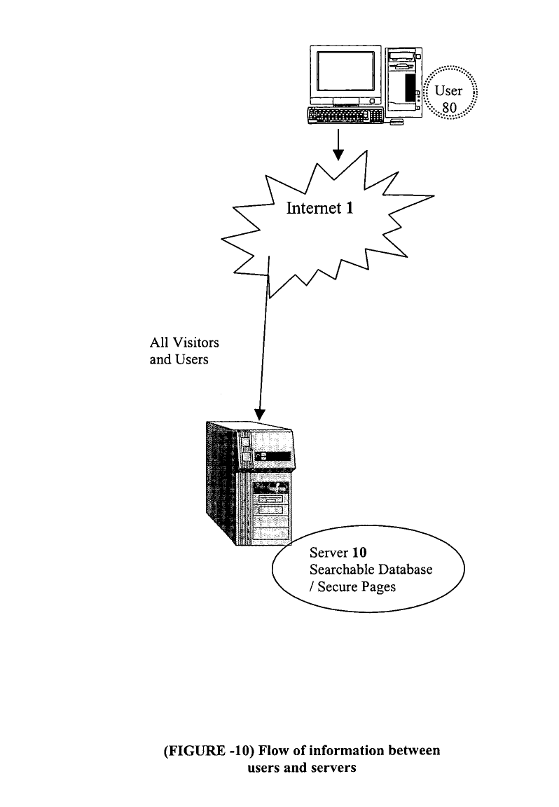

The system according to the invention is preferably implemented using a web site accessible via the Internet and World Wide Web as seen in FIG. 10. FIG. 10 shows a preferred embodiment of the system, in which users 80 are able to connect to web server 10 via the Internet 1 using software, such as a browser. Web server 10 stores the web site and contains the searchable database 15 accessible to users 80. Users 80 may perform a search using search module 25 (described below and with reference to FIGS. 1 and 2) and obtain search results from web server 10. A user 80 may submit a new professional name or company, or a comment (including video comments), via their browser using the appropriate module. This submitted information is then refreshed and stored in web server 10, and becomes a part of the searchable database 15 for future searches.

In a preferred embodiment, subscription users (members) may post resumes or modify and change their profile stored on database 15 using post resume module 60, purchase advertisement spots using the purchase advertising module 70 and bid, using the bidding module 80, for the opportunity to place advertisements in advertising spots, and this information submitted by the users will be stored in database 15 accessible by server 10, both of which are preferably secured. Database 15 stores all personal and financial information submitted by users on secure pages. Preferably, all users can access web server 10 to search and view displays of information and advertisements and are able to leave comments or add a professional to the database. In a preferred embodiment only users that are subscriber users will be able to access web server 10 to take advantage of other modules and related features therein.

Web server 10 may be conventional server, having input means, such as a mouse and keyboard, output means, such as a monitor and speakers, a CPU, RAM, and a hard drive and/or other computer readable storage means. Server 10 may be implemented as software on a computer, or may include one or more computers.

Database 15 is a conventional database with records relating to users and professionals. Fields associated with users 80 (in the case user 80 is a subscription user) would preferably include email address, user ID, password, payment information, comments made, payment information and whether or not the user is a professional. Fields associated with a professional record would preferably include contact information, the category of professional and any subcategories, comments and ratings for the professional, the other professionals making the particular professional (for example the lawyers at a law firm, or the doctors at a medical clinic), advertisements, and advertising history, bids, profile and payment information.

User 80 will typically be using a computer from which user 80 can access the Internet, typically a PC, but may also be a PDA, a Blackberry device, or a cellular phone.

The web site on web server 10 will allow the sharing of information with other users and will assist them in making decisions about using a professional. The web site will allow users to obtain categorized information about different professionals (for example their skill level, customer service level, events, etc.).

For example, a user may be considering going to a dentist and may want to know who the best dentist is in his or her area. To obtain this information, the user can access the web site and select the search criteria to obtain the desired details. Users will be at liberty to share their comments, good or bad, about any services received from the professional. Such comments may be stored as video, allowing users to demonstrate the services received from the professional (for example, good or poor work performed by contractors). Users 80 will also have an outlet for their frustration if they have had a bad experience in dealing with a professional.

The web site allows users 80 to leave and share their good and bad comments about any specific professionals, but also provides an automatic responder that generates a message via email for that particular professional, if such professional is also a subscription user, asking the professional, or a representative thereof, to access the web site and view the comments. Should such professional so desire, the professional can post a response to the comment (optionally, rather than an automatic email responder, the professional can also be notified by phone using prerecorded voice messages or by a live representative). The comments from users 80 can also be used by the professionals to improve their services. The web site may also provide a platform for users 80 to find or to share their remarks about professionals in specific areas. This will not only help those professionals improve their services, but may also attract users 80 to high quality but perhaps less well known professionals.

As seen in FIG. 1, when a user using an Internet browser connects to the web page, a number of options for selection will be presented to them. One available option will be for user to search through the searchable database. When a user elects to search (step 102) and enters a query, the system sends the search results to web server 10 and displays them to the user's browser. The options to add a professional's name (individual or corporate/partnership) (step 103), or to add comments (step 104) are also available to all users. Users, who are also professionals, and wish to add their own company/partnership or name (step 110), require a user ID and password for accessing the subscription user modules (i.e. such user must be a subscription user).

Should a user wish to post a resume or modify/upgrade profile (step 106), post an advertisement (step 107) or participate in an advertisement bidding process (step 108), the system will prompt the user to inquire if they have a user ID (step 109). If the answer provided is no, then a registration process (step 150) is provided to user 80 acquire the user ID. If the user has already acquired a user ID through the registration module 150, the user will have to provide the user ID and password (step 160) in order to gain further access. After the user has provided the necessary information, they can access the modules for modifying/upgrading profile (step 131), posting a resume (step 161), posting an advertisement (step 171) and participating in bidding (step 181). All of these processes provide information to server 10 for storage in database 15 on secure pages.

As seen in FIG. 2 the default selection of the web page for executing a search (step 202) will preferably correspond to the country from where the Internet 1 is accessed. For example, searching from a “.com” or “.ca” web site may default to Canada, whereas from a “.net” web site may default to the United States. However, user 80 can select a different country (step 210) to perform a search for professionals in such country. The search web page will refresh according to the country selection. All users, whether or not subscription users, may use the search module. To conduct a search for a particular professional, the user enters a keyword (such as individual name, company or partnership name, phone number, or profession related word) (step 220) or leaves the search options blank. Some professions may be represented by several different combinations, for example lawyers would appear on lists corresponding to “LAW”, as well as those corresponding to “BAR” (barristers) and “SOL” (solicitors). User 80 selects the desired primary category from the drop down list (step 250) or leaves it blank, then selects the corresponding subcategory (step 260) (if primary category is selected in step 250), then selects province or state (step 230) and city (step 240). The selection of city (step 240) and state/province (step 230) are optional, but help narrow down the search. In the case where the city is left blank, the results for the entire state/province will be displayed. The user can also enter a company or partnership name (step 220) and/or a particular professional individual's name (step 220). If these fields are left blank then all of the professionals meeting the selected criteria (geographical and the appropriate profession) are displayed. From this display, the user may further select criteria (step 280) and the displayed results will be refreshed (step 295) according to the selected criteria (step 280). These criteria may include selecting a particular category or subcategory selection, for example, a name, a rating, the top ten rated, the most frequently voted for, or the least expensive. After the search has been conducted, the results are sent to and displayed on the user's browser.

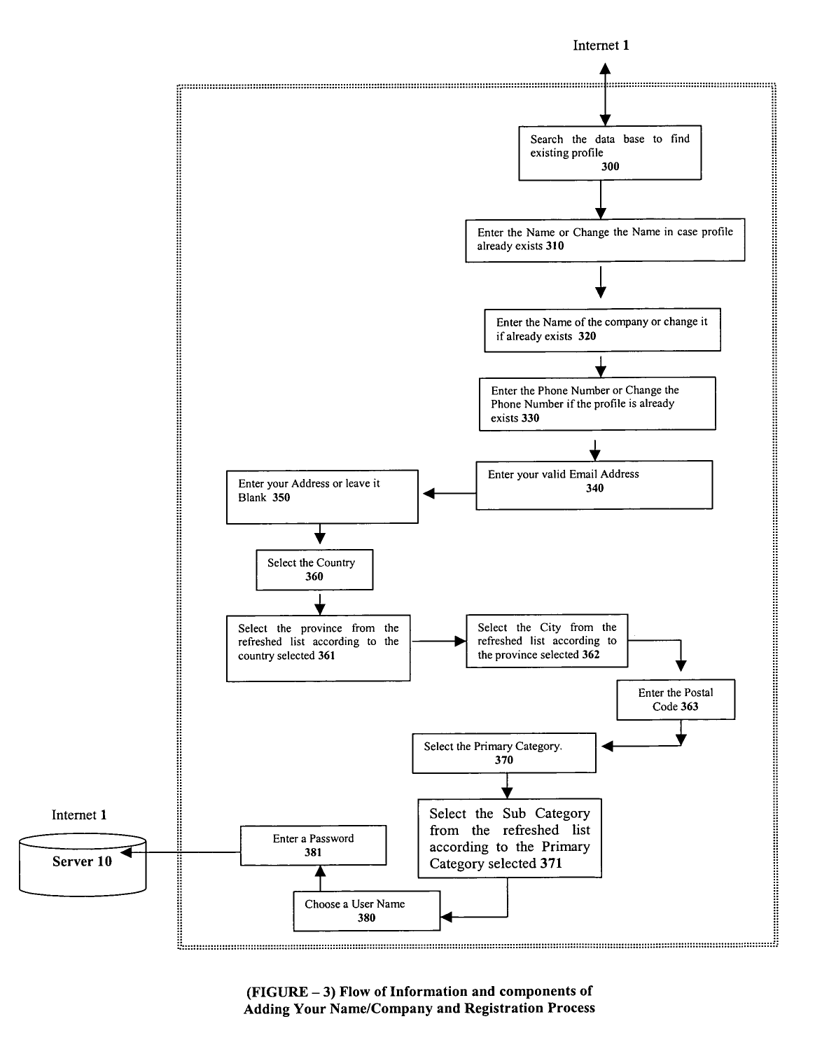

A subscription user 80 can add a professional name, a professional company/partnership or a new profession, as seen in FIG. 3. If the search process shown in FIG. 2 fails to locate a desired professional, then user 80 is presented with two options, one of which is to add the professional (or his or her's company or partnership) to the database as shown in FIG. 3. First the database is searched to check the availability of the desired professional (step 300). The following steps will depend on whether or not the professional is already present in the database. If the professional is present, then the user may change information relating to the professional. If the professional is not included in the database, then information about the professional can be entered in the database. Depending on whether the professional is already in the database or not, the user may enter or change the name of the professional (step 310), enter or change the name of the company or partnership (step 320), enter or change the phone number of the professional (step 330), enter a valid email address for the user and for the professional (340), enter or change an address or leave it blank (350), select a country (step 360), select a province or state according to the country selected (step 361), from the refreshed list select a city (step 362), enter or change a postal code or ZIP code (step 363), select a primary category (step 370) and corresponding subcategory (step 371), and select a user name and password (steps 380 & 381) (if becoming a subscription user). The primary category as previously described will be the general type of professional, for example accountant, doctor or the like. The subcategory is a subset of professionals in the main category. For example, different medical specialties could be subsets of the category “doctor”. Likewise, different legal specialties could be subsets of the category “lawyer”. The user then selects the country (step 360), the province/state of the professional (step 361) and the city (step 362). As these are related, the drop down province/state and city lists are refreshed to correspond to the selected country and province/state, and preferably, all three entries are mandatory.

If the user is adding a new professional to the database, as shown in the FIG. 1, the user will be prompted by an email module (step 170 seen in FIG. 1). After the process of adding the professional to the database 15, the administrator sends an email to the said user, which confirms that the professional has been added to database 15. Such email message includes a hyperlink which leads the email recipient to a web page on which they can leave comments about that professional.

In a preferred embodiment of the invention, only professionals are permitted to add themselves to the database, although this obviously reduces the scope of professionals that will be available to be searched. In yet another alternative embodiment, all professionals added to the database 15 must be confirmed by a system administrator, who may notify the professional that they have been added.

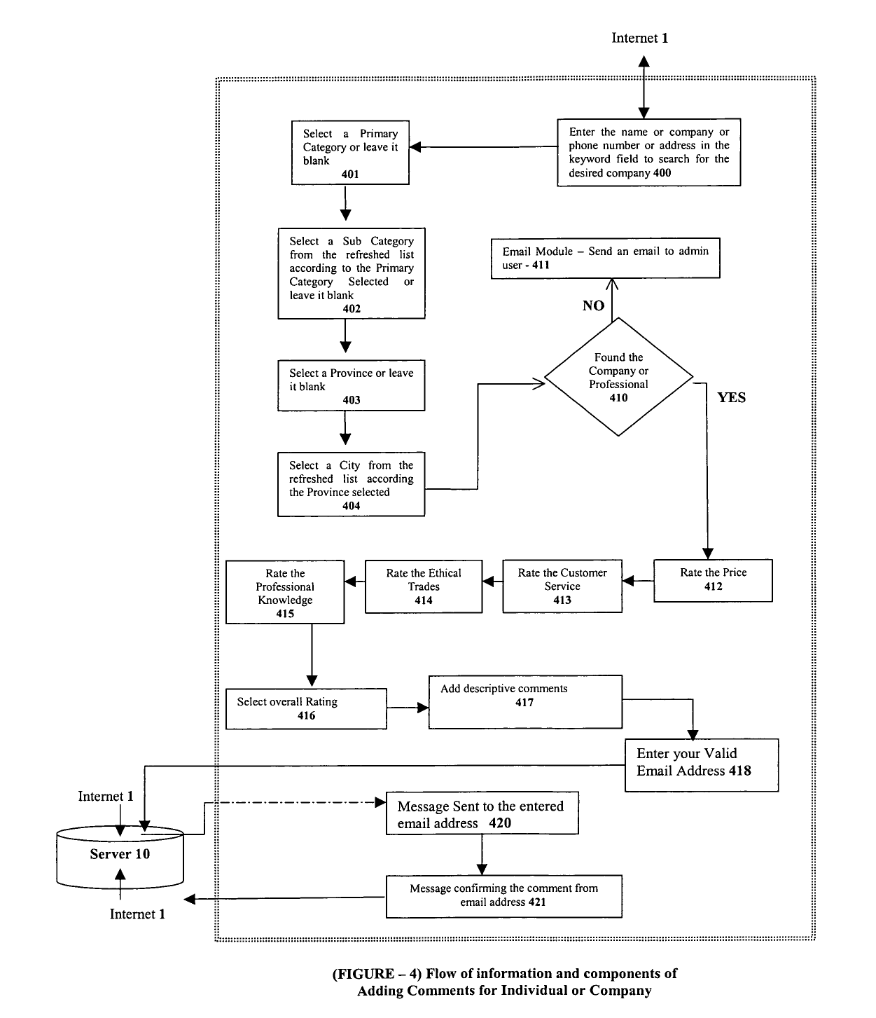

Users may leave comments and remarks about professionals as shown in FIG. 4. This module may be accessed either after a search or directly by selection of the add comment option from the web site. For the add comment module, the user will perform a search as described earlier (steps 400 to 404) in order to find the desired professional. If the user finds the professional (step 410), the user selects the “Add Comment” option on the result page which then activates the add comment module (steps 412 to 416). The user may rate price (step 412), customer service (step 413), ethics/honesty (step 414), professional knowledge (step 415) and may provide an over all rating (step 416). In a preferred embodiment, all ratings are between 1 to 5, 1 being very poor and 5 being excellent, although other rating systems (e.g. letter grades, scores out of one hundred, etc. may be used). After the ratings have been provided, the user is prompted to provide a descriptive comment (step 417). In a preferred embodiment, the user is also able to add a video comment (as described below). In order for the comments and ratings to be stored and posted, the user has to leave a valid email address (step 418). When the comment is submitted, the system sends an electronic message (step 420) to the email address entered by the user in step 418. The user then must access his/her email account and agree to the terms of services provided by the system, confirming acceptance of these terms (step 421) by clicking the link sent in the email. When the administrator of the system approves the comment, the comment is stored in the database 15 for future reference. If user does not find the desired professional or company after the search (steps 400 to 404), then the name of the company or professional may be submitted to the administrator of the system for addition to the database 15, using the email module (step 411). When the request for adding a professional for comments purposes is submitted to system via the administrator, then the system sends an email to the user containing a link to the desired professional once the professional is entered in the database 15, allowing the user to rate the professional and leave a comment.

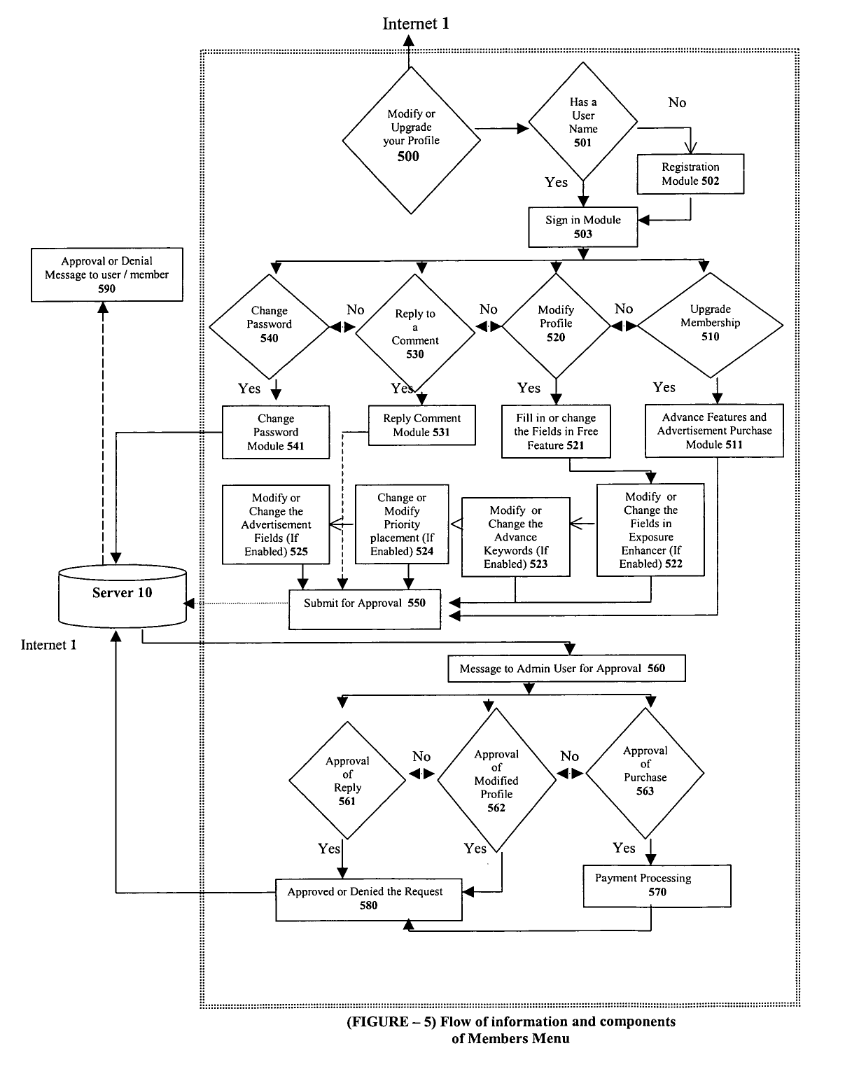

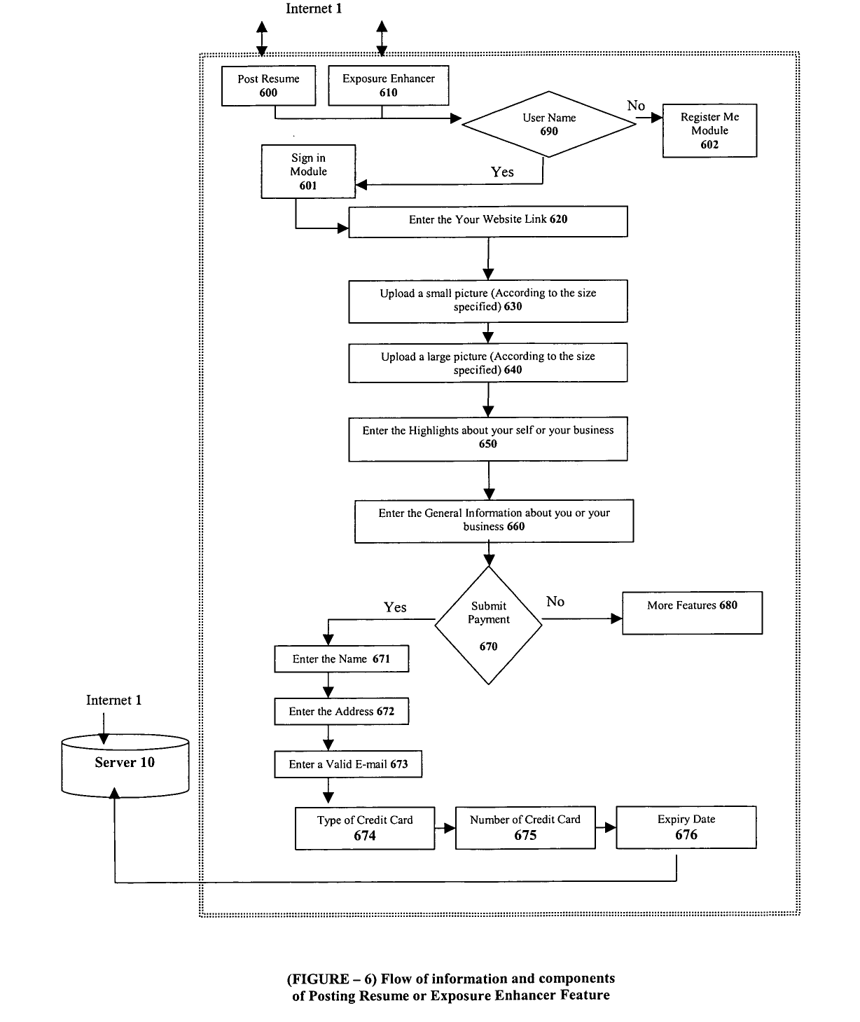

As seen in FIG. 5 a user may access the modify or upgrade profile module (step 106; FIG. 1). This module is preferably accessible by subscription users only and when a user selects this option, the system checks if the user has a user ID using cookies or similar means (step 501). If the user ID is available, the sign in module (step 503) is used to allow the subscription user to login, otherwise the registration module (step 502) is activated. When the subscription user provides the user ID and password in the sign in module (step 503) the subscription user accesses the member's menu page where a number of options are available, preferably including upgrade membership (step 510), modify profile (step 520), reply to a comment (step 530), and change password (step 540). Changes or modifications to advertisements may be accessed by the modify profile module (step 520). The purchase of any advanced features or advertisements is done by the upgrade membership module (step 510). If a subscription user opts to upgrade their membership (step 510), the advanced features, namely exposure enhancer, advanced keyword selection, or priority placement or advertisement purchase module (step 511), they proceed to the appropriate web page, as described below with reference to FIGS. 6, 7 and 8. After the selected module is complete the changes are submitted for approval (step 550) to server 10. When the modify profile module (step 520) is selected, the subscription user can enter or change the fields in free features (step 521), then change the advance features and advertisement options which are highlighted according to the purchase made in the upgrade membership module (steps 510 & 511), which can be modified. Free features are certain information related to a professional that can be provided to users at no cost, and preferably include the professional's individual name; company/partnership or business name; phone numbers; fax numbers; email address(es); address; category; subcategory; and free keywords (preferably limited to a number of characters, for example 25 characters).

A subscription user can also change or modify the fields in the exposure enhancer (if enabled) (step 522), change or modify the advance keywords (if enabled) (step 523), change or modify their priority placement (if enabled) (step 524) and change or modify their advertisement (if enabled) (step 525). After all changes or modifications are made they are submitted for approval (step 550) to server 10. When the subscription users submit any of these requests, the system sends a message to the administrator of the system and approval or denial (step 580) is provided by the administrator. In the case of an upgrade membership request (step 510), the system also processes payment (step 570). The approval of a change (or lack thereof) is sent to the server 10, where it is stored in database 15 for future reference.

FIG. 6 displays the flow of information and procedure for posting a resume (step 600) or enhancing a professional's exposure using the exposure enhancer module (step 610). The exposure enhancer is an advanced feature, which is available on payment. In this feature, the subscription user (member) can upload a small and a large picture or logo, a website link, highlights about the business or company/partnership and some general information, to the web site. For highlights and general information two font editable portions are provided to members, which enable them to choose the font size, type and color. The additional information is stored in database 15, and provided to a user when the professional is provided in search results. The enhanced exposure option allows the member to provide display more information about the business, company or service offered by the professional.

Preferably, these features are available only to subscription users, so when a user accesses these modules the system first determines the availability of user ID. If the user does not have user ID, then the registration module (step 602) is called, otherwise the sign in module (step 601) is activated. After entering the user ID and password in the sign in module (step 601), the subscription user may enter their website link (step 620), upload a small picture, according to a specified size (step 630), upload a large picture, according to a specified size (step 640), enter a brief description (step 650), and/or enter general information (step 660). In a preferred embodiment, videos can be uploaded as part of the enhanced posting. The subscription user is then prompted to query if they want to submit the payment after this module (step 670). If they opt not to, then the subscription user may proceed to more features (step 680) to access further modules (but the enhancements will not be added to database 15 until payment is made). If the subscription user opts to pay, they then enter the name for payment (step 671), enter the address (step 672), enter a valid email address (step 673), enter the type of credit card (step 674), enter the number of credit card (step 675) and the expiry date of credit card (step 676), and submit the information to server 10 for payment processing.

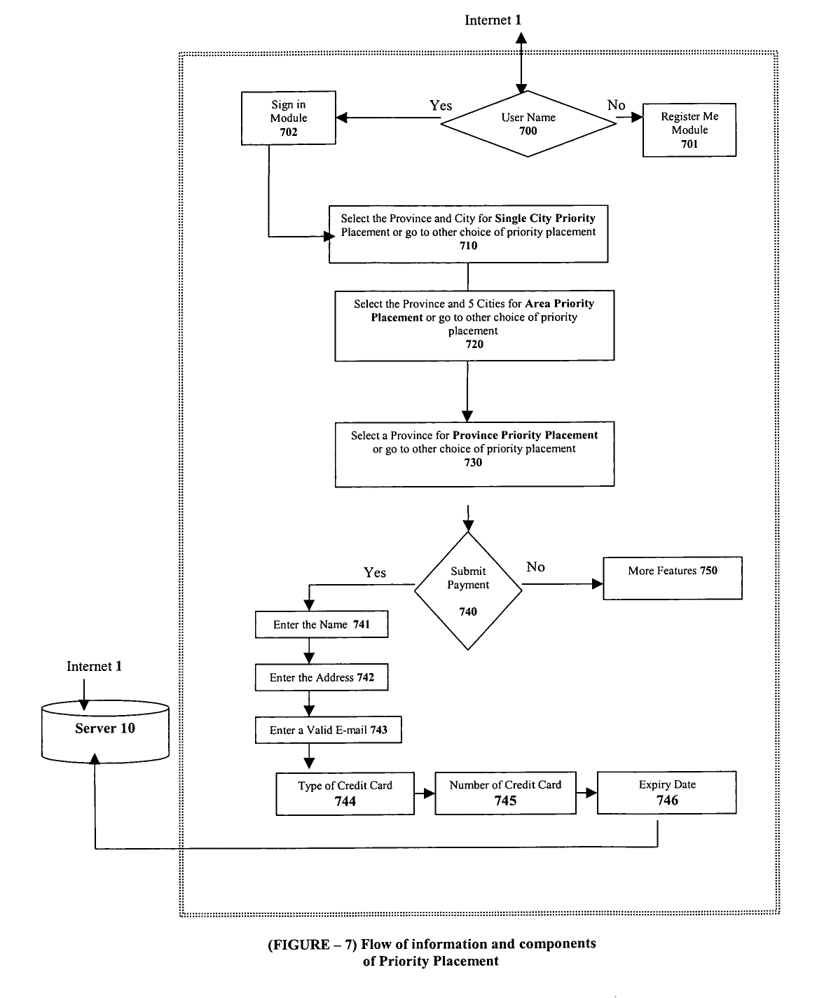

FIG. 7 displays the process of purchasing priority placement. Priority placement is another advanced feature offered by the system. There are preferably three levels of this feature, single city priority placement, area priority placement (including a fixed number of cities) and province/state priority placement. If a member chooses single city priority placement, then any searches in database 15 selecting that city will result in the profile of such member being shown on the beginning of the result page. The other options, such as area priority placement provides this feature for a fixed number (for example, five) cities and the province/state priority placement applies to all cities in the province/state and searches in the province/state not based on a particular city. In the case of competing priority placements (for example different professionals have purchased province/state priority placement and city priority placement for a city in such province/state), then hierarchy for searches for professionals in such city are: province/state priority placement is displayed first; area priority placement next; and then city priority placement. In the case of different members who have purchased the same level of priority placement, the results will be randomly displayed, meaning that on every load of the search results page, different professionals with the same level of priority placement may be displayed at the beginning of the list.

The priority placement feature is available to subscription users as, when accessed, the system checks for a user ID (step 700). If the user ID is available, then the sign in module is launched (step 762), otherwise the user goes through a registration process (step 701). After providing a user ID and password (step 702), the subscription user selects one of single city priority (step 710) (allowing selection of a province/state and a city); area priority (step 720) (allowing selection of five cities (preferably within a single province/state); or province/state priority (step 730) (allowing selection of a province or state). The user is then prompted to provide payment (step 740), and if the user elects not to, then they may access more features (step 750) (but the priority placement will not be implemented until payment is made). If the user opts to submit payment, then they enter the name (step 741), the address (step 742), a valid email (step 743), type of credit card (step 744), number of credit card (step 745) and expiry date (step 746). This information is then submitted to the server 10 for processing.

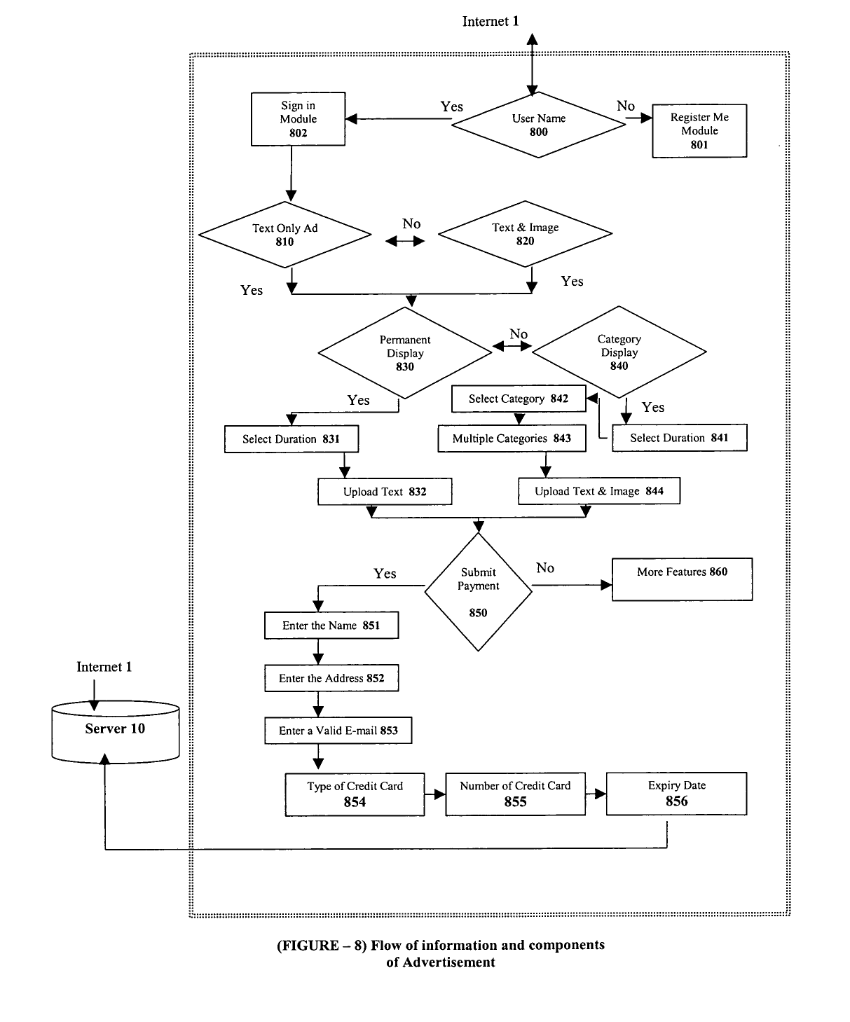

In FIG. 8, a preferred embodiment of the process of purchasing advertisements is displayed. There are two main types of advertisements, those related to a particular category, and those that are independent of the categories. When a user conducts a search by selecting a particular category or a keyword connected with a category, then appropriate advertisements will be displayed. The advertisements connected to a particular category will only be displayed when either that specific category or any keyword connected to the category is selected during a search. The advertisements which are independent of categories may be displayed whenever a search is made or comment is viewed, regardless of the search criteria. In both types of advertisement, the selection of advertisement for display is random among other advertisements with the same criteria, so the advertisements may be displayed in a random fashion on every load of that page. The sizes of the advertisements will vary depending upon the type e.g. text only, or text and image advertisements, and the advertising spot available.

The purchase advertising module is accessible to subscription users only and the system determines the availability of the user ID (step 800). If the user does not have a user ID, the registration process (step 801) becomes active, but in case a user ID is available, the sign in module (step 802) activates. A subscription user then has two options available, either to have a text only advertisement (step 810) or a text and image advertisement (step 820). After selecting which type of advertisement, there are two additional options, which is whether the advertisement is to be indefinitely displayed (step 830) or displayed according to category (step 840). If the user selects indefinite display (step 830), then the user selects the duration for the advertisement to be displayed (for example in weeks or months) (step 831), uploads the text and image, if appropriate (step 832) and is prompted to submit payment (step 850). If the user opts not to pay, they are prompted to access more features (step 860) (but the options selected will not be processed until payment is made). If the user elects to pay, they enter their name (step 851), address (step 852), a valid email address (step 853), the type of credit card (step 854), number of credit card (step 855) and the expiry date (step 856). This information is then submitted to server 10 for processing. If user 80 selects an advertisement displayed according to the category (step 840), the user 80 selects the duration (step 841), and a category (step 842) or multiple categories (step 843), and uploads the text and image for the advertisement (or text only, if appropriate) (step 844). The user 80 is then prompted to submit payment (step 850), as described above.

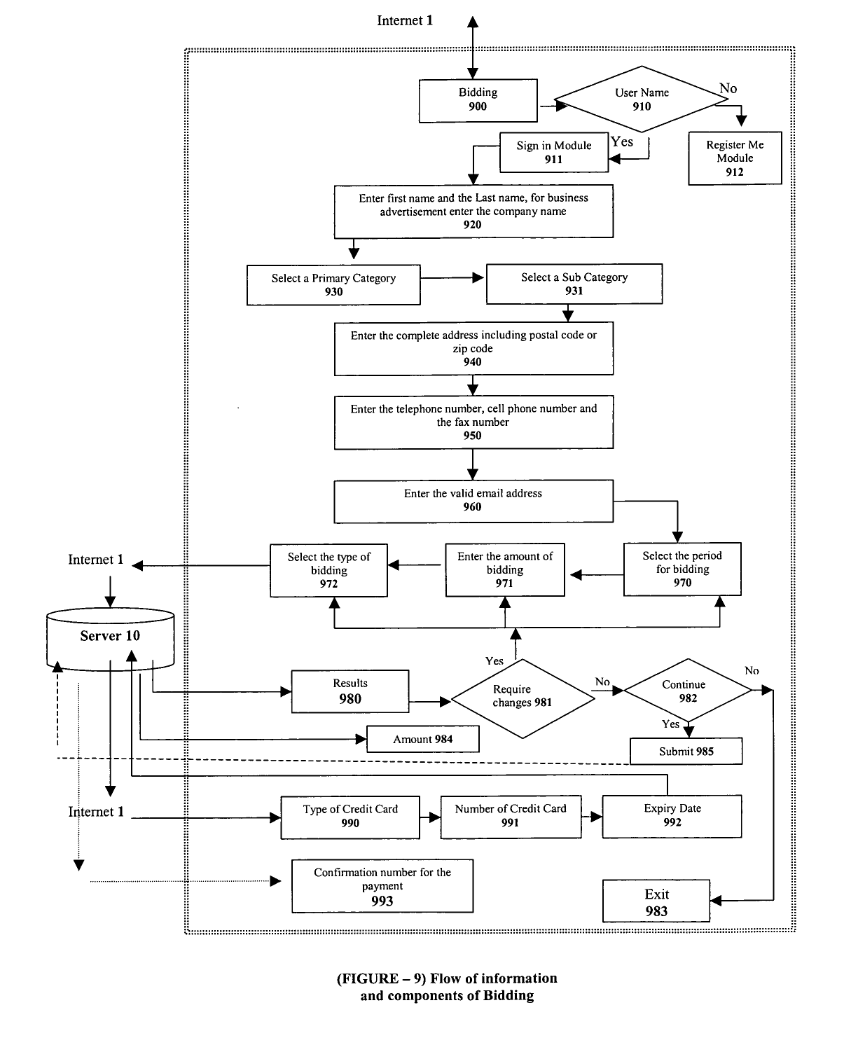

A preferred embodiment of the bidding process according to the invention is seen in FIG. 9. This module is preferably accessible to subscription users only. When the bidding module is accessed (step 900) the system checks for a user ID (step 910). If no user ID is available, the registration process (step 912) is activated but if the user ID is available, the user ID and password are entered in the sign in module (step 911). After sign in, the complete name of the professional is provided (step 920), the primary category selected (step 930), the sub category selected (step 931), the complete address including postal or zip code provided (step 950), and valid email address provided (step 960). The period of bidding is then selected (in a preferred embodiment it may be weekly or monthly) (step 970), the amount of the bid is selected (step 971), and the type of bidding (step 972) is selected. The type of bidding may be “indefinite” or “category related”. This information is then submitted to the server 10. The system sends the subscription user an acceptance or denial message (step 980) via the email address provided (step 960). This message also contains the link for making changes or submitting payment. In a preferred embodiment, there are four main types of advertisements to bid on: banner advertisements, text advertisements, box (i.e. text and image) advertisements, and any of the preceding types of advertisements. The bidder will be able to make one or multiple selections at this stage. If the user wants to make changes to the bid (step 981), then they repeat steps 970 to 972, but if no changes are required, then they may exit the module without submitting payment (step 983) or submit payment information to server 10. When the information is submitted to server 10, it is stored on secure pages and the server will bring forward the financial information previously provided by the subscription user 80. Alternatively, the user may make the payment by entering credit card type (step 990), number of the credit card (step 991) and expiry date (step 992), and submitting the information to the server 10. After the processing of the payment system sends a confirmation to the email address (submitted at step 960), the message contains the details of the payment and the approval of bidding with the duration.

At the end of each bidding period the highest bidder will “win’ the auction, and the user's advertisements will be displayed during searches and on the web site. Furthermore, it is possible to provide advertisements based on search terms and categories/subcategories. For example, a law firm's advertisements will be displayed when a user is searching for a law firm. Searches can also be based on geographical inputs, so for instance, a law firm in a particular city will have its advertisements displayed only when a user is searching for a law firm in that particular city.

The add video module (step 1000) option is accessible by users. The system begins by asking for the user name and password (step 1010). If the user does not have a user name and password then the Registration Module is called (step 1020). If the user has already provided or can provide the user name and password then they proceed through the sign in module (step 1030), and are given the option to upload a video (step 1040). Once the video file is uploaded, the system checks the format and the size of the file (step 1050), and if the file meets the predetermined specifications (1060), it is submitted for approval to the administrator (step 1080). If the file does not meet the specifications, an error message is generated (step 1070). When the file is submitted for approval, the administrator views the file to check the content thereof, and if approved the video file is stored in the database (step 1090) and is available for display.

When the error message is generated (step 1070), the user is given the option to reload the file according to the specifications, or to load a different file.

The system and method described herein may be represented in executable code stored on a computer readable medium. Furthermore, the method according to the invention may be represented in a plurality of formats and instructions in a digital media, executable by a computer.

Although the particular preferred embodiments of the invention have been disclosed in detail for illustrative purposes, it will be recognized that variations or modifications of the disclosed apparatus lie within the scope of the present invention.

What is claimed is:

1. A method of rating a professional comprising:
(a) providing a database, said database containing a plurality of records, each of said records relating to a professional, each of said records storing the name and contact information of said professional;
(b) searching said database for a particular professional using a web site;
(c) if said professional is present in a record in said database, providing a rating for said professional; and
(d) if said professional is not present in a record in said database, providing the name and contact information of said professional to said database, and providing a rating for said professional.

2. The method of claim 1, wherein said rating may be based on the expertise of said professional, the cost of said professional or the ethics of said professional.

3. The method of claim 2 wherein step (b) further comprises:
selecting a category of professionals.

4. The method of claim 3 wherein step (b) further comprises:
selecting a subcategory of professionals.

5. The method of claim 4, wherein step (b) further comprises:
selecting a geographic area for said professional.

6. The method of claim 5 wherein said web site is accessible to users searching for said rating of said professional.

7. The method of claim 6 wherein said web site provides an advertisement.

8. The method of claim 7 wherein a second professional bids on said advertisement.

9. The method of claim 8, wherein said second professional, if successful in said bid, may select said advertisement for display on said web site.

10. The method of claim 9, wherein in step (c) a comment may be provided in addition to said rating.

11. The method of claim 10, wherein said comment is provided in a video file.

12. A system for rating professionals, comprising:
(a) means for storing information about a plurality of professionals in a database, including a name and contact information for each of said professionals;
(b) means for a user to search said database via a web site;
(c) means for said user provide the name and contact information of a professional to said database; and
(d) means for said user to provide a rating of said professional.

13. The system of claim 12, wherein said rating may be based on the expertise of said professional, the cost of said professional, or the ethics of said professional.

14. The system of claim 13 wherein said means for said user to search said database comprises selecting a category of professionals.

15. The system of claim 14 wherein said means for said user to search said database further comprises selecting a subcategory of professionals.

16. The system of claim 15, wherein said means for said user to search said database further comprises selecting a geographic area for said professional.

17. The system of claim 16 wherein said web site is accessible to a second user to access said rating of said professional.

18. The system of claim 17 wherein said web site provides an advertisement.

19. The system of claim 18 further comprising means for a second professional to bid on said advertisement.

20. The system of claim 19, wherein said second professional, if successful in said bid, may select said advertisement for display on said web site.

21. The system of claim 20, further comprising means to provide a comment about said professional.

22. The system of claim 21, wherein said comment may be provided in a video file.
